(19) United States
(12) Patent Application Publication
(10) Pub. No.: US 2012/0074030 A1
(43) Pub. Date: Mar. 29, 2012

(54) MUSICAL FRAGRANCE CONTAINER

(76) Inventor: Martinis Butler, Lawton, OK (US)

(21) Appl. No.: 12/890,706

(22) Filed: Sep. 26, 2010

(51) Int. Cl. B65D 85/00; G10D 15/00

(52) U.S. Cl. 206/525; 84/170

(57) ABSTRACT

A musical fragrance container comprising a bottle to house a scent, a nozzle attached to a top portion of said bottle to evacuate said scent, a musical attachment connected to a portion of said bottle, a speakers built within said musical attachment to enable a sound to emit, and an actuator affixed to said musical attachment wherein said actuator causes said musical attachment to play said sound when activated by a user.

### BACKGROUND OF THE INVENTION

1. Field of the Invention

The present invention relates to a novelty device which is a fragrance container to play music when a nozzle is sprayed.

2. Description of Related Art

For many years, perfumes, scented oils and body fragrances have been popular with men and women alike. Fragrances are available anywhere from a department store, a high end boutique to even a grocery store. Some people prefer a spicy oriental type smell while others may prefer a more citrus or a floral aroma. With such a plethora of fragrances available, usually an individual is able to find a scent they find pleasing which may reflect their personal style and personality. For those individuals struggling to find their perfect scent, perfumeries or custom mixing shops offer a way to create a personal fragrance. A person need only the time and their sense of smell to individually select the exact oils and perfumes to create a customized scent specifically designed for them.

Recently, celebrities ranging from musicians to movie stars to heiresses are releasing their own custom blends of perfumes onto the market for people to purchase. Typically the celebrity collaborates with a perfume specialist and selects their favorite aromas and flavors to custom mix a new fragrance. A lot of effort and money is put into the packaging and bottling of the celebrity fragrances so as to appeal to the consumer's liking. The consumers not only compare scents created but also compare the celebrities endorsing the fragrances and the attractiveness of the bottles or packaging.

It would be beneficial in the art to provide yet another appealing quality to offer to the consumer when selecting a new fragrance.

### SUMMARY OF THE INVENTION

The present invention relates to a novelty device to enable a fragrance container to play music each time the container is sprayed. The general purpose of the present disclosure is to provide a musical fragrance container comprising a bottle to house a scent, a nozzle attached to a top portion of said bottle to evacuate said scent, a musical attachment connected to a portion of said bottle, a speakers built within said musical attachment to enable a sound to emit, and an actuator affixed to said musical attachment wherein said actuator causes said musical attachment to play said sound when activated by a user.

These together with other aspects of the present invention, along with the various features of novelty that characterize the present invention, are pointed out with particularity in the claims annexed hereto and form a part of this present invention. For a better understanding of the present invention, its operating advantages, and the specific objects attained by its uses, reference should be made to the accompanying drawings and descriptive matter in which there are illustrated exemplary embodiments of the present invention.

### BRIEF DESCRIPTION OF THE DRAWINGS

The advantages and features of the present invention will become better understood with reference to the following detailed description and claims taken in conjunction with the accompanying drawings, wherein like elements are identified with like symbols, and in which:

FIG. 1 depicts a perspective view of a musical fragrance container in accordance with an exemplary embodiment of the present invention; and

FIG. 2 depicts a perspective view of a musical fragrance container in accordance with an alternative embodiment of the present invention.

Like reference numerals refer to like parts throughout the description of several views of the drawings.

### DETAILED DESCRIPTION OF THE DRAWINGS

The present invention relates to a novelty device which comprises a fragrance container and a musical attachment to play music when a nozzle is sprayed. The musical fragrance container may enhance a user's enjoyment and experience when applying their favorite perfume or scent. The musical attachment may affix to an atomizer of perfume to play a sound or song when the atomizer is activated. An enclosed hard drive may store one or more songs complementary to the product, and when activated begins to play. The song may sound when the nozzle or a button connected to the musical attachment is pressed. Thus, the user receives the benefit of not only dispensing their favorite scent but also enjoying a fun song or sound to provide a complete sensory experience.

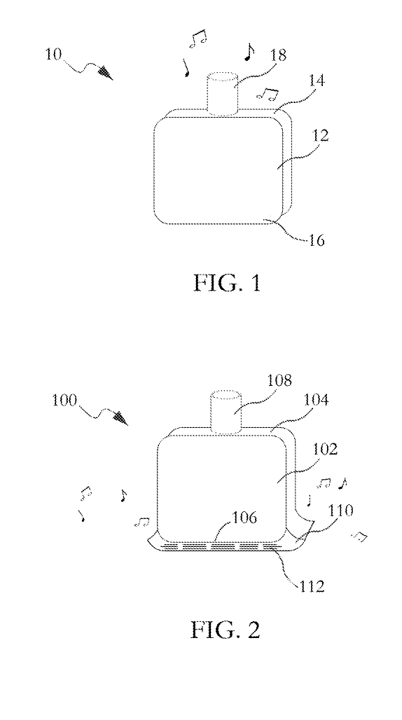

Turning now descriptively to the drawings, referring to FIG. 1, a perspective view of a musical fragrance container (10) is shown in accordance with an exemplary embodiment of the present invention. The musical fragrance container (10) may be a perfume bottle or an atomizer, a body splash bottle or a body spray container. The musical fragrance container (10) may comprise a bottle (12) and a musical attachment. The bottle (12) includes a top (14) and a bottom (16) or base. The top (14) may enable a cap (18) or lid to rest against a top portion of the bottle (12). The musical attachment may be built into the cap (18) as shown in FIG. 1. The musical attachment may be activated when a user presses a nozzle to dispense a scented mist or a button attached on the musical attachment. One or more songs may play when the musical attachment is activated. The musical attachment may include an enclosed internal hard drive, powered by a coin lithium battery. A speaker or set of speakers may be housed within the musical attachment to enable the user to hear what is playing. A prerecorded song, jingle or melody may sound when the musical attachment is activated. An alternative option provides a recording device within the musical attachment to allow the user to record their own message or voice and play it back when the musical attachment is activated. Many perfume containers feature a celebrity or musical artist, thus a song sung by the particular artist may be uploaded onto the musical attachment.

Referring now to FIG. 2, a perspective view of a musical fragrance container (100) is shown in accordance with an alternative embodiment of the present invention. The musical fragrance container (100) may comprise a bottle (102) and a musical attachment (110) connected to a bottom portion (106) or base of the bottle (102). The musical attachment (110) may comprise a speaker (112) or set of speakers to amplify the sounds and music played. Along a top portion (104) of the bottle (102) may be a cap (108) with a nozzle secured beneath the cap (108). The nozzle may activate the musical attachment (110) to play. Alternatively, a button affixed to the musical attachment may start the music to enable the user to play the music without requiring them to dispense the fragrance. The musical fragrance container (100) allows the users to listen to their favorite songs while dispensing their favorite scents.

The foregoing descriptions of specific embodiments of the present invention have been presented for purposes of illustration and description. They are not intended to be exhaustive or to limit the invention to the precise forms disclosed, and obviously many modifications and variations are possible in light of the above teaching. The exemplary embodiment was chosen and described in order to best explain the principles of the invention and its practical application, to thereby enable others skilled in the art to best utilize the invention and various embodiments with various modifications as are suited to the particular use contemplated.

What is claimed is:

1. A musical fragrance container comprising:
a bottle to house a scent;
a nozzle attached to a top portion of said bottle to evacuate said scent;
a musical attachment connected to a portion of said bottle;
a speakers built within said musical attachment to enable a sound to emit; and
an actuator affixed to said musical attachment wherein said actuator causes said musical attachment to play said sound when activated by a user.

2. The musical fragrance container of claim 1, wherein said musical attachment and said speakers are attached to said top portion of said bottle.

3. The musical fragrance container of claim 1, wherein said nozzle activates said actuator to enable said scent to dispense at a same time as said sound plays.

4. The musical fragrance container of claim 1, wherein said musical attachment and said speakers are attached to a bottom portion of said bottle.

5. The musical fragrance container of claim 1, wherein said musical attachment contains a recording device to enable said user to record a voice and play back said voice when said actuator is pressed.
